(19) United States
(12) Patent Application Publication
(10) Pub. No.: US 2022/0267221 A1
(43) Pub. Date: Aug. 25, 2022

(54) HONEYCOMB FILTER AND MANUFACTURING METHOD OF THE SAME

(71) Applicant: NGK Insulators, Ltd., Nagoya-City (JP)

(72) Inventors: Yu TORII, Inazawa-City (JP); Shungo NAGAI, Nagoya-City (JP)

(73) Assignee: NGK Insulators, Ltd., Nagoya-City (JP)

(21) Appl. No.: 17/451,859

(22) Filed: Oct. 22, 2021

(30) Foreign Application Priority Data
Feb. 22, 2021 (JP) 2021-026632

(51) Int. Cl. C04B 38/00; C04B 38/06; B01D 46/24; B01D 46/00

(52) U.S. Cl. CPC C04B 38/0012; C04B 38/0009; C04B 38/0054; C04B 38/0058; C04B 38/0645; C04B 38/064; B01D 46/24491; B01D 46/2429; B01D 46/24492; B01D 46/2482; B01D 46/2474; B01D 46/0001

(57) ABSTRACT

A honeycomb filter includes a pillar-shaped honeycomb structure body having a porous partition wall disposed to surround a plurality of cells and a plugging portion provided at an open end on a first end face side or a second end face side of the cells, wherein the partition wall is composed of a material containing cordierite as a main component, a porosity of the partition wall is 60 to 70%, an average pore diameter of the partition wall is 20 to 30 μm, an open porosity of pores existing at the partition wall surface and having equivalent circle diameters exceeding 1.5 μm is 31% or more, and, in a pore diameter distribution which indicates a cumulative pore volume of the partition wall, a half-value width of a first peak including a maximum value of a log differential pore volume is 0.20 or less.

The present application is an application based on JP 2021-026632 filed on Feb. 22, 2021 with Japan Patent Office, the entire contents of which are incorporated herein by reference.

### BACKGROUND OF THE INVENTION

### Field of the Invention

The present invention relates to a honeycomb filter, and a manufacturing method of the same. More specifically, the present invention relates to a honeycomb filter in which an increase in pressure loss is suppressed, and a manufacturing method thereof.

### Description of the Related Art

Hitherto, as a filter adapted to trap particulate matter in an exhaust gas emitted from an internal combustion engine, such as an automobile engine, there has been known a honeycomb filter that uses a honeycomb structure. The honeycomb structure has a porous partition wall composed of cordierite or the like, and a plurality of cells are defined by the partition wall. In the honeycomb filter, the foregoing honeycomb structure is provided with, for example, plugging portions that alternately plug the open ends on the inflow end face side of the plurality of cells and the open ends on the outflow end face side thereof. In the honeycomb filter, the porous partition wall functions as a filter that traps the particulate matter in an exhaust gas.

The honeycomb structure can be manufactured by adding a pore former, a binder and the like to a ceramic raw material powder to prepare a plastic kneaded material, forming the obtained kneaded material into a predetermined shape to obtain a formed body, and firing the obtained formed body (refer to, for example, Patent Documents 1 and 2). As a ceramic raw material powder, a cordierite forming raw material or the like is known.
[Patent Document 1] JP-A-2002-326879
[Patent Document 2] JP-A-2003-238271

### SUMMARY OF THE INVENTION

According to the conventional manufacturing methods of a honeycomb filter, a method has been tried, in which, at the time of manufacturing a honeycomb structure, the particle size of a cordierite forming raw material is not controlled, and hollow resin particles of a foamable resin or the like, or water-swellable particles of crosslinked starch or the like are used for pore formers. However, it has been impossible to manufacture honeycomb filters that satisfy current exhaust gas regulations by such a conventional manufacturing method.

The present invention has been made in view of the problems with the prior arts described above. The present invention provides a honeycomb filter in which an increase in pressure loss is suppressed, and a manufacturing method of the same.

According to the present invention, there is provided a honeycomb filter, and a manufacturing method of the same, which are described below.

[1] A honeycomb filter including:

a pillar-shaped honeycomb structure body having a porous partition wall disposed to surround a plurality of cells which serve as fluid through channels extending from a first end face to a second end face; and

a plugging portion provided at an open end on the first end face side or the second end face side of each of the cells,

wherein the partition wall is composed of a material containing cordierite as a main component thereof,

a porosity of the partition wall is 60 to 70%,

an average pore diameter of the partition wall is 20 to 30 μm,

an open porosity of pores which exist at a surface of the partition wall and which have equivalent circle diameters exceeding 1.5 μm is 31% or more, and,

in a pore diameter distribution which indicates a cumulative pore volume of the partition wall, with a log pore diameter on a horizontal axis and a log differential pore volume (cm³/g) on a vertical axis, a half-value width of a first peak that includes a maximum value of the log differential pore volume is 0.20 or less.

[2] The honeycomb filter according to [1], wherein an average equivalent circle diameter of the pores which exists at the surface of the partition wall and which have equivalent circle diameters exceeding 1.5 μm is 5.0 to 15.0 μm.

[3] The honeycomb filter according to [1] or [2], wherein the half-value width of the first peak is less than 0.20.

[4] The honeycomb filter according to any one of [1] to [3], wherein the thickness of the partition wall is 152 to 305 μm.

[5] A manufacturing method of a honeycomb filter according to any one of [1] to [4] including:

a kneaded material preparation process for preparing a plastic kneaded material by adding an organic pore former and a dispersing medium to a cordierite forming raw material;

a forming process for forming the obtained kneaded material into a honeycomb shape to produce a honeycomb formed body; and

a firing process for firing the obtained honeycomb formed body to obtain a honeycomb filter,

wherein the cordierite forming raw material contains at least one of porous silica and fused silica as an inorganic pore former,

in a cumulative particle size distribution of the porous silica and the fused silica as the inorganic pore former based on volume by the laser diffraction/scattering type particle size distribution measurement method, a particle diameter (μm) of 10% by volume of a total volume from a small diameter side is denoted by D₍ₐ₎10, a particle diameter (μm) of 50% by volume of the total volume from the small diameter side is denoted by D₍ₐ₎50, a particle diameter (μm) of 90% by volume of the total volume from the small diameter side is denoted by D₍ₐ₎90, and the inorganic pore former that satisfy a relationship of following expression (1) is used.

1.00<(D₍ₐ₎90−D₍ₐ₎10)/D₍ₐ₎50<1.50 Expression (1):

The honeycomb filter of the present invention has an effect of suppressing an increase in pressure loss. Further, the manufacturing method of the honeycomb filter of the present invention has an effect that it is possible to easily manufacture a honeycomb filter in which an increase in pressure loss is suppressed.

### BRIEF DESCRIPTION OF THE DRAWINGS

FIG. 1 is a perspective view schematically showing one embodiment of a honeycomb filter of the present invention as viewed from the inflow end face side.

FIG. 2 is a plan view as viewed from the inflow end face side of the honeycomb filter shown in FIG. 1.

FIG. 3 is a sectional view schematically showing the section taken along the line A-A′ of FIG. 2.

### DESCRIPTION OF THE PREFERRED EMBODIMENTS

Hereinafter, embodiments of the present invention will be described; however, the present invention is not limited to the following embodiments. Therefore, it should be understood that, without departing from the spirit of the present invention, those obtained by adding changes, improvements or the like to the following embodiments, as appropriate, on the basis of the common knowledge of one skilled in the art are also covered by the scope of the present invention.

(1) Honeycomb Filter

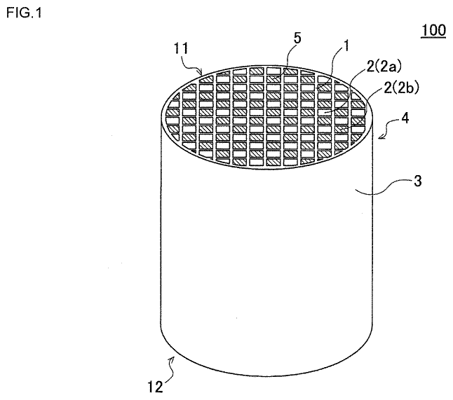

As shown in FIG. 1 to FIG. 3, a first embodiment of the honeycomb filter in accordance with the present invention is a honeycomb filter 100 that includes a honeycomb structure body 4 and plugging portions 5. The honeycomb structure body 4 is a pillar-shaped structure having a porous partition wall 1 disposed so as to surround a plurality of cells 2 that serve as fluid through channels extending from a first end face 11 to a second end face 12. In the honeycomb filter 100, the honeycomb structure body 4 is pillar-shaped and further includes an outer circumferential wall 3 on the outer circumferential side face. In other words, the outer circumferential wall 3 is provided to encompass the partition wall 1 provided in a grid pattern. The plugging portions 5 are provided at open ends on the first end face 11 side or the second end face 12 side of each of the cells 2.

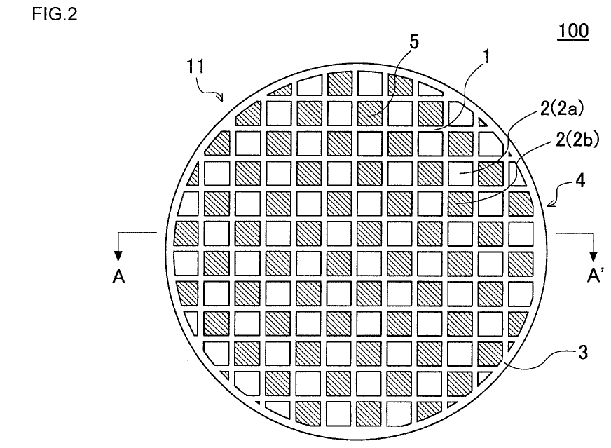

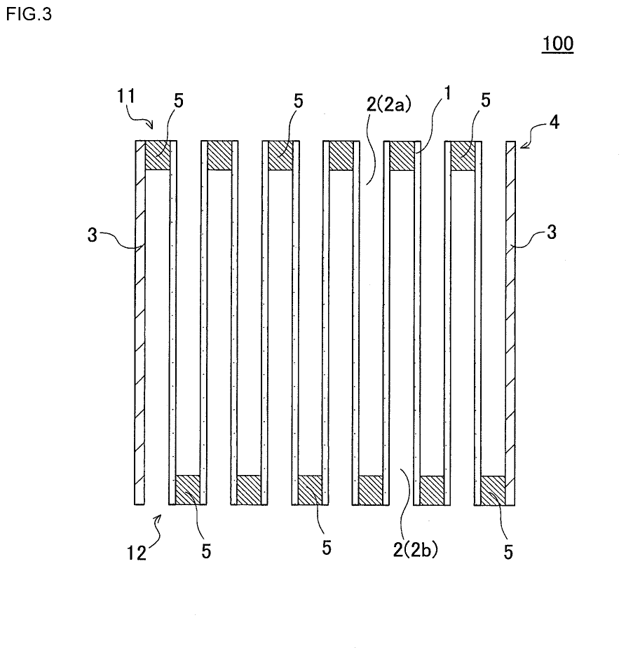

FIG. 1 is a perspective view schematically showing one embodiment of a honeycomb filter in accordance with the present invention viewed from an inflow end face side. FIG. 2 is a plan view of the honeycomb filter shown in FIG. 1, viewed from the inflow end face side. FIG. 3 is a sectional view schematically showing a section A-A′ of FIG. 2.

In the honeycomb filter 100, the partition wall 1 constituting the honeycomb structure body 4 is configured as described below. First, the partition wall 1 is composed of a material that contains cordierite as the main component thereof. The partition wall 1 is preferably composed of cordierite except for components that are inevitably contained.

In the honeycomb filter 100, a porosity of the partition wall 1 is 60 to 70%. The porosity of the partition wall 1 is based on values measured by the mercury press-in method, and can be measured using, for example, Autopore IV (trade name) manufactured by Micromeritics. To measure the porosity, a part of the partition wall 1 is cut out as a test piece from the honeycomb filter 100, and the obtained test piece can be used for the measurement. As a test piece for the measurement of the porosity, a test piece configured in the same manner as a test piece for cumulative pore volume measurement described later can be suitably used. Note that the porosity of the partition wall 1 is not particularly limited as long as it is 60 to 70%, but is preferably 63 to 70%

In the honeycomb filter 100, the average pore diameter of partition wall 1 is 20 to 30 μm. The average pore diameter of the partition wall 1 is based on values measured by the mercury press-in method, and can be measured using, for example, Autopore IV (trade name) manufactured by Micromeritics. When measuring the average pore diameter, a part of the partition wall 1 can be cut out as a test piece from the honeycomb filter 100, and the obtained test piece can be used. The average pore diameter of the partition wall 1 is not particularly limited as long as it is 20 to 30 μm, but is preferably 23 to 30 μm.

In the partition wall 1 constituting honeycomb structure body 4, an open porosity of pores which exist at a surface of the partition wall 1 and which have equivalent circle diameters exceeding 1.5 μm is 31% or more. Hereinafter, the open porosity of pores which exist at a surface of the partition wall 1 and which have equivalent circle diameters exceeding 1.5 μm may be simply referred to as “the open porosity (%) of the surface of the partition wall 1”. If the open porosity of the surface of the partition wall 1 is less than 31%, it is not effective enough to suppress an increase in pressure loss. The open porosity of the surface of the partition wall 1 is not particularly limited as long as it is 31% or more, but is preferably 34% or more. The upper limit value of the open porosity of the surface of the partition wall 1 is not particularly limited, but the upper limit value of the open porosity of the surface of the partition wall 1 may be, for example, 45%.

The open porosity of the surface of the partition wall 1 can be measured by the following methods. First, a sample for measurement is cut out from the honeycomb structure body 4 so as to observe the surface of the partition wall 1 of the honeycomb structure body 4. Then, the surface of the partition wall 1 of the sample for measurement is photographed by a laser microscope. The laser microscope that can be used is, for example, a shape analysis laser microscope of “VK X250/260 (trade name)” manufactured by KEYENCE Corporation. In photographing the surface of the partition wall 1, the magnification is set to 480 times, and arbitrary places of 10 fields of view are photographed. The captured images were subjected to image processing and the open porosity (%) of the surface of the partition wall 1 was calculated. In the image processing, an area is selected such that no portion of the partition wall 1 except the surface of the partition wall 1 is included in the area to be subjected to the image processing, and the inclination of the surface of the partition wall 1 is corrected to be horizontal. Thereafter, the upper limit of the height for being recognized as pores is changed to −3.0 μm from a reference surface. The surface open porosity (%) of the captured image is calculated using the image-processing software under the condition that pore with a circle equivalent diameter of 1.5 μm or less is ignored. The equivalent circle diameter (μm) of the pores of the surface of the partition wall 1 can be calculated by measuring an opening area S of each pore and applying an expression of the equivalent circle diameter=√{4× (area S)/π} with respect to the area S that has been measured. The value of the open porosity (%) of the surface of the partition wall 1 is the average value of the measured results of 10 fields of view (i.e., the surface open porosity (%) of the respective captured images of 10 fields of view). The image processing software that can be used is, for example, “VK-X (trade name)” included with the shape analysis laser microscope of “VK X250/260 (trade name)” manufactured by KEYENCE Corporation. The measurement of the equivalent circle diameter of each pore and the image analysis ignoring pores that have predetermined equivalent circle diameters can be performed using the image processing software described above.

Furthermore, the honeycomb filter 100 has a first peak configured as follows in a pore diameter distribution which indicates a cumulative pore volume of the partition wall, with a log pore diameter on a horizontal axis and a log differential pore volume (cm³/g) on a vertical axis. The “first peak” is a peak that includes the maximum value of the log differential pore volume in the pore diameter distribution. The half-value width of the first peak is 0.20 or less. The “half-value width of the first peak” means the value of a pore diameter corresponding to a ½ value width of the maximum value of the log differential pore volume of the first peak. Hereinafter, “the value of a pore diameter corresponding to a ½ value width of the maximum value of the log differential pore volume of the first peak” may be referred to simply as “the half-value width of the first peak”.

When the half-value width of the first peak is 0.20 or less, the first peak has a sharp distribution in the pore diameter distribution of the partition wall 1. By setting the half-value widths of the first peaks to 0.20 or less while porosity and the average pore diameter of partition wall 1 and the open porosity of the surface of the partition wall 1 satisfy the numerical ranges described above, the increase in pressure loss of the honeycomb filter 100 can be effectively suppressed. For example, when the half-value width of the first peak exceeds 0.20, the first peak becomes broad, and it is difficult to obtain adequate effects for suppressing the increase in pressure loss. The half-value width of the first peak is preferably less than 0.20. The lower limit value of the half-value width of the first peak is not particularly limited, but is, for example, about 0.05. For this reason, for example, the half-value width of the first peak is preferably 0.05 or more and 0.20 or less, more preferably 0.05 or more and less than 0.20.

The cumulative pore volume of the partition wall 1 is a value measured by the mercury press-in method. The measurement of the cumulative pore volume of the partition wall 1 can be performed using, for example, Autopore IV (trade name) manufactured by Micromeritics. The measurement of the cumulative pore volume of the partition wall 1 can be performed by the following method. First, a part of the partition wall 1 is cut out from the honeycomb filter 100 to make a test piece for measuring the cumulative pore volume. The size of the test piece is not particularly limited, but is preferably, for example, a rectangular parallelepiped having a length, a width, and a height of approximately 10 mm, approximately 10 mm, and approximately 20 mm, respectively. A portion of the partition wall 1 from which the test piece is cut out is not particularly limited, but the test piece is preferably made by cutting from the vicinity of the center of the honeycomb structure body in the axial direction. The obtained test piece is placed in a measurement cell of a measurement device, and the interior of the measurement cell is depressurized. Next, mercury is introduced into the measurement cell. Next, the mercury that has been introduced into the measurement cell is pressurized, and the volume of the mercury pushed into the pores existing in the test piece is measured during the pressurization. At this time, as the pressure applied to the mercury is increased, the mercury is pushed into the pores progressively from pores having larger pore diameters and then to pores having smaller pore diameters. Consequently, the relationship between “the pore diameters of the pores formed in the test piece” and “the cumulative pore volume” can be determined from the relationship between “the pressure applied to the mercury” and “the volume of the mercury pushed into the pores”. More particularly, as described above, by the mercury press-in method, when a gradual pressure is applied to intrude the mercury into pores of the sample in a container sealed in a vacuum state, the pressurized mercury intrudes into the larger pores and then into the smaller pores of the sample. Based on the pressure and the amount of mercury intruded at that time, the pore diameters of the pores formed in the sample and the volumes of the pores can be calculated. Hereinafter, when the pore diameters are denoted by D1, D2, D3 . . . , the relationship of D1>D2>D3 . . . is to be satisfied. In this case, an average pore diameter D between measurement points (e.g., from D1 to D2) can be indicated on the horizontal axis by “the average pore diameter D=(D1+D2)/2”. The log differential pore volume on the vertical axis can be indicated by a value obtained by dividing an increment dV of the pore volume between measurement points by a difference value treated as the logarithms of the pore diameters (i.e., “log (D1)−log (D2)”). In a graph showing such a pore diameter distribution, a peak means a turning point indicated by the distribution, and a peak that includes the maximum value of the log differential pore volume is defined as the first peak. The “cumulative pore volume” refers to, for example, a value obtained by accumulating the pore volumes from a maximum pore diameter to a particular pore diameter.

In the partition wall 1 constituting the honeycomb structure body 4, the average value of the equivalent circle diameter (μm) of pores which exist at a surface of the partition wall 1 and which have equivalent circle diameters exceeding 1.5 μm is preferably 5.0 to 15.0 μm, and more preferably 7.0 to 15.0 μm. Hereinafter, “the average value of the equivalent circle diameter (μm)” will be referred to as “the average equivalent circle diameter (μm)”. The “average equivalent circle diameter (μm) of pores which exist at a surface of the partition wall 1 and which have equivalent circle diameters exceeding 1.5 μm” may be simply referred to as “average equivalent circle diameter (μm) of pores on the surface of the partition wall 1”. If the average equivalent circle diameter of pores on the surface of the partition wall 1 is below 5.0 μm, it is not preferable in terms of an increase in pressure loss after coating a catalyst. The average equivalent circle diameter (μm) of pores on the surface of the partition wall 1 can be calculated based on the image analysis result at the time of measuring the open porosity (%) of the surface of the partition wall 1 described above.

In the honeycomb filter 100, the thickness of the partition wall 1 is preferably 152 to 305 μm, and more preferably 203 to 305 μm. A thickness of the partition wall 1 that is below 152 μm is not desirable in respect of strength. A thickness of the partition wall 1 that exceeds 305 μm is not desirable in respect of pressure loss.

The cell densities of honeycomb structure body 4 are preferably, for example, 23 to 62 cells/cm², more preferably 27 to 47 cells/cm².

The shape of the cells 2 formed in the honeycomb structure body 4 is not particularly limited. For example, the shape of the cells 2 in the section that is orthogonal to the extending direction of the cell 2 may be polygonal, circular, elliptical or the like. Examples of the polygonal shape include a triangle, a quadrangle, a pentagon, a hexagon, and an octagon. The shape of the cells 2 is preferably triangular, quadrangular, pentagonal, hexagonal, or octagonal. Further, regarding the shapes of the cells 2, all the cells 2 may have the same shape or different shapes. For example, although not shown, quadrangular cells and octagonal cells may be combined. Further, regarding the sizes of the cells 2, all the cells 2 may have the same size or different sizes. For example, although not shown, some of the plurality of cells may be made large, and other cells may be made relatively smaller. In the present invention, the cells 2 mean the spaces surrounded by the partition wall 1.

The circumferential wall 3 of the honeycomb structure body 4 may be configured integrally with the partition wall 1 or may be composed of a circumferential coat layer formed by applying a circumferential coating material to the circumferential side of the partition wall 1. For example, although not shown, the circumferential coat layer can be provided on the circumferential side of the partition wall after the partition wall and the circumferential wall are integrally formed and then the formed circumferential wall is removed by a publicly known method, such as grinding, in a manufacturing process.

The shape of the honeycomb structure body 4 is not particularly limited. The honeycomb structure body 4 may be pillar-shaped, the shapes of the first end face 11 (e.g., the inflow end face) and the second end face 12 (e.g., the outflow end face) being circular, elliptical, polygonal or the like.

The size of the honeycomb structure body 4, for example, the length from the first end face 11 to the second end face 12, and the size of the section that is orthogonal to the extending direction of the cells 2 of the honeycomb structure body 4, is not particularly limited. Each size may be selected as appropriate such that optimum purification performance is obtained when the honeycomb filter 100 is used as a filter for purifying exhaust gas.

In the honeycomb filter 100, the plugging portions 5 are provided at the open ends on the first end face 11 side of predetermined cells 2 and at the open ends on the second end face 12 side of the remaining cells 2. If the first end face 11 is defined as the inflow end face, and the second end face 12 is defined as the outflow end face, then the cells 2 which have the plugging portions 5 provided at the open ends on the outflow end face side and which have the inflow end face side open are defined as inflow cells 2a. Further, the cells 2 which have the plugging portions 5 provided at the open ends on the inflow end face side and which have the outflow end face side open are defined as outflow cells 2b. The inflow cells 2a and the outflow cells 2b are preferably arranged alternately with the partition wall 1 therebetween. In addition, this preferably forms a checkerboard pattern by the plugging portions 5 and “the open ends of the cells 2” on both end faces of the honeycomb filter 100.

The material of the plugging portions 5 is preferably a material that is preferred as the material of the partition wall 1. The material of the plugging portions 5 and the material of the partition wall 1 may be the same or different.

In the honeycomb filter 100, the partition wall 1 which defines the plurality of cells 2 may be loaded with a catalyst. Loading the partition wall 1 with a catalyst refers to coating the catalyst onto the surface of the partition wall 1 and the inner walls of the pores formed in the partition wall 1. This configuration makes it possible to turn CO, NOx, HC, and the like in exhaust gas into harmless substances by catalytic reaction. In addition, the oxidation of PM of trapped soot or the like can be accelerated.

(2) Manufacturing Method of the Honeycomb Filter

The manufacturing method of the honeycomb filter of the present embodiment is not particularly limited, and the manufacturing method can be one that includes, for example, a kneaded material preparation process, a forming process, and a firing process, as described below.

The kneaded material preparation process is a process for preparing a plastic kneaded material by adding an organic pore former and a dispersing medium to a cordierite forming raw material. The forming process is a process for forming the kneaded material obtained by the kneaded material preparation process into a honeycomb shape to make a honeycomb formed body. The firing process is a process for firing the honeycomb formed body obtained in the forming process to obtain a honeycomb filter. The following will describe in more detail each process in the manufacturing method of the honeycomb filter.

(1-1) Kneaded Material Preparation Process

In the kneaded material preparation process, first, the cordierite forming raw material, the organic pore former, and the dispersing medium, which are the raw materials of the kneaded material, are prepared. The “cordierite forming raw material” is a ceramic raw material blended so as to have a chemical composition in which silica is in the range of 42 to 56% by mass, alumina is in the range of 30 to 45% by mass, and magnesia is in the range of 12 to 16% by mass, and the ceramic raw material is fired to become cordierite.

In the kneaded material preparation process, a cordierite forming raw material that contains at least one of porous silica and fused silica is preferably used. The porous silica and the fused silica are a silicon source of a silica composition in the cordierite forming raw material, and function also as an inorganic pore former. The porous silica preferably has a BET ratio surface area of 100 to 500 m²/g, and more preferably 200 to 400 m²/g, measured according to JIS-R1626, for example. Hereinafter, the porous silica and the fused silica contained in cordierite forming raw material may be simply referred to as “inorganic pore former” or “silica-based inorganic pore former”. In other words, an inorganic pore former contained in the cordierite forming raw material means the porous silica or the fused silica, or both the porous silica and the fused silica, unless otherwise specified.

For the cordierite forming raw material, in addition to the foregoing porous silica and fused silica, a plurality of types of raw materials that become a magnesium source, a silicon source, and an aluminum source can be mixed and used so as to have a chemical composition of cordierite. Examples of the cordierite forming raw material include talc, kaolin, alumina, aluminum hydroxide, boehmite, crystalline silica, and dickite.

The organic pore former is a pore former that contains carbon as a raw material, any such pore former may be used insofar as it has a property of being dispersed and lost by firing in the firing process described later. The material of the organic pore former is not particularly limited, and examples thereof include a polymer compound such as a water-absorbing polymer, starch, foamable resin, and the like, a polymethyl methacrylate (PMMA), coke, and the like. The organic pore formers include not only pore formers made mainly of organic substances but also pore formers such as charcoal, coal, and coke, which are dispersed and lost by firing.

In the kneaded material preparation process, it is preferable to use a porous silica and a fused silica whose particle size is adjusted as follows, as an inorganic pore former. In the cumulative particle size distributions based on the volume of porous silica and fused silica as the inorganic pore former, particle diameter of 10% by volume of a total volume from a small diameter side is defined as D₍ₐ₎10, particle diameter of 50% by volume of the total volume from the small diameter side is defined as D₍ₐ₎50, and particle diameter of 90% by volume of the total volume from the small diameter side is defined as D₍ₐ₎90. Each unit of D₍ₐ₎10, D₍ₐ₎50, D₍ₐ₎90 is “μm”. The cumulative particle size distributions of porous silica and fused silica as inorganic pore former are measured by the laser diffraction/scattering type particle size distribution measurement method. In the kneaded material preparation process, it is preferable to use a porous silica and a fused silica as an inorganic pore former satisfying the relationship of the following expression (1). Hereinafter, in each raw material used as a raw material, simply referred to as “D50” means a particle diameter (μm) of 50% by volume of the total volume from the small diameter side in the cumulative particle size distribution of raw material. In other words, “D50” means a median diameter. The cumulative particle size distribution of each raw material can be measured using, for example, a laser diffraction/scattering type particle diameter distribution measuring device (trade name: LA-960) manufactured by HORIBA, Ltd.

1.00<(D₍ₐ₎90−D₍ₐ₎10)/D₍ₐ₎50<1.5 Expression (1):

The upper limit value in Expression (1) is 1.5 as described above, but is preferably, for example, 1.3.

The particle diameter and the like of the porous silica and the fused silica as the inorganic pore former are not particularly limited as long as it satisfies the above expression (1). However, the median diameter D₍ₐ₎50 of the porous silica and the fused silica is preferably 30.0 to 40.0 μm, more preferably 35.0 to 40.0 μm.

The cordierite forming raw material preferably contains 10.0 to 25.0 parts by mass of at least one of porous silica and fused silica as the inorganic pore former described above in 100 parts by mass of the cordierite forming raw material, and more preferably contains 15.0 to 25.0 parts by mass. If the content ratio of the porous silica is below 10.0 parts by mass, then the effect of pore forming may become difficult to be exhibited, which is not desirable.

In the kneaded material preparation process, a dispersing medium is added to the cordierite forming raw material in which the particle sizes have been adjusted as described above and the organic pore former, and then the mixture is blended and kneaded thereby to prepare a plastic kneaded material. The dispersing medium may be, for example, water. When preparing the kneaded material, a binder, a surfactant, and the like may be further added.

Examples of the binder include hydroxypropylmethyl cellulose, methyl cellulose, hydroxyethyl cellulose, carboxylmethyl cellulose, polyvinyl alcohol and the like. These may be used by one type alone, or may be used in combination of two or more types. As the surfactant, for example, dextrin, fatty acid soap, polyether polyol and the like can be used. These may be used alone or in combination of two or more.

The method of preparing the kneaded material by blending and kneading a cordierite forming raw material and the like is not particularly limited, and examples thereof include a method of blending and kneading by a kneader, a vacuum pugmill or the like.

(1-2) Forming Process

In the forming process, the kneaded material obtained in the kneaded material preparation process is formed into a honeycomb shape to produce a honeycomb formed body. The forming method used for forming the kneaded material into a honeycomb shape is not particularly limited, and examples thereof include conventionally known forming methods such as extrusion, injection molding, and press molding. Among these forming methods, a method of extruding the kneaded material prepared as described above by using a die corresponding to a desired cell shape, a partition wall thickness, and a cell density can be mentioned as a preferred example.

The honeycomb formed body obtained by the forming process is a pillar-shaped formed body that has a partition wall disposed so as to surround a plurality of cells that extend from the first end face to the second end face. The honeycomb formed body is fired so as to be the honeycomb structure body 4 in the honeycomb filter 100 shown in FIG. 1 to FIG. 3.

The obtained honeycomb formed body may be dried to obtain a honeycomb dried body from the honeycomb formed body. The drying method is not particularly limited, and examples thereof include hot air drying, microwave drying, dielectric drying, decompression drying, vacuum drying, and freeze drying. Among these, dielectric drying, microwave drying, and hot air drying are preferably performed alone or in combination.

In the forming process, the plugging portions are preferably formed by plugging the open ends of the cells of the honeycomb formed body. The plugging portions can be formed according to a conventionally known manufacturing method of honeycomb filter. For example, as the method for forming the plugging portions, the following method can be mentioned. First, water and a binder or the like are added to a ceramic raw material to prepare a slurry plugging material. As the ceramic raw material, for example, the cordierite forming raw material or the like used to produce the honeycomb formed body can be used. Then, the plugging material is filled into the open ends of predetermined cells from the first end face side of the honeycomb formed body. When filling the plugging material into the open ends of the predetermined cells, preferably, for example, the first end face of the honeycomb formed body is provided with a mask to close the open ends of the remaining cells other than the predetermined cells, and the plugging material is selectively filled into the open ends of the predetermined cells. At this time, the slurry plugging material may be stored in a storage container, and the first end face side of the honeycomb formed body provided with the mask may be immersed in the storage container to fill the plugging material. Then, the plugging material is filled into the open ends of the remaining cells other than the predetermined cells from the second end face side of the honeycomb formed body. As the method for filling the plugging material, the same method as that for the predetermined cells described above can be used. The plugging portions may be formed before drying the honeycomb formed body or after drying the honeycomb formed body.

(1-3) Firing Process

The firing process is a process for firing the honeycomb formed body obtained in the forming process thereby to obtain a honeycomb filter. The temperature of a firing atmosphere for firing a honeycomb formed body is preferably, for example, 1300 to 1450° C., and more preferably 1400 to 1450° C. Further, the firing time is preferably set to 2 to 8 hours as the time for keeping a maximum temperature.

The specific method of firing a honeycomb formed body is not particularly limited, and a firing method in a conventionally known manufacturing method of honeycomb filter can be applied. For example, the firing method can be implemented using an existing continuous firing furnace (e.g., tunnel kiln) or a batch firing furnace (e.g., shuttle kiln), which is provided with a charge port at one end and a discharge port at the other end of a firing path.

### EXAMPLES

The following will describe in more detail the present invention by examples, but the present invention is not at all limited by the examples.

### Example 1

Talc, kaolin, alumina, aluminum hydroxide, and silica-based inorganic pore former were prepared as cordierite forming raw material. Silica-based inorganic pore former is a raw material made of at least one of porous silica and fused silica. Silica-based inorganic pore former was utilized as an inorganic pore former as well as a silicon source as a silica composition. Then, the cumulative particle size distribution of each raw material was measured using the laser diffraction/scattering type particle diameter distribution measurement device (trade name: LA-960) manufactured by HORIBA, Ltd. In Example 1, the raw materials were blended to prepare the cordierite forming raw materials such that the blending ratios (parts by mass) of the raw materials exhibited the values shown in Table 1. In Table 1, the horizontal row of “Particle size D50 (μm)” shows the particle diameter of 50% by volume (i.e., a median diameter) of each raw material. In addition, “Particle size D50 (μm)” of the silica-based inorganic pore former means particle diameter of 50% by volume (D₍ₐ₎50) of porous silica and fused silica as inorganic pore former.

Next, 5 parts by mass of organic pore former, 6 parts by mass of binder, 1 parts by mass of surfactant, and 85 parts by mass of water were added to 100 parts by mass of cordierite forming raw material to prepare a kneaded material. The organic pore former having a particle diameter of 50% by volume of 30 μm was used. Table 1 shows the blending ratio (parts by mass) of the organic pore formers and other raw materials. In Table 1, the horizontal row of “Particle size D50 (μm)” shows the particle diameter of 50% by volume (i.e., the median diameter) of the organic pore formers. In addition, the blending ratio (parts by mass) shown in Table 1 shows the ratio with respect to 100 parts by mass of the cordierite forming raw material.

In addition, D₍ₐ₎10, D₍ₐ₎50, D₍ₐ₎90 of the silica-based inorganic pore former was obtained from the cumulative particle size distributions on a volume basis of the silica-based inorganic pore former, and the values of “(D₍ₐ₎90−D₍ₐ₎10)/D₍ₐ₎50” were calculated. The calculated results are shown in the column of “Value of Expression (1) of the silica-based inorganic pore former” in Table 2. That is, in Table 2, the column of “Value of Expression (1) of the silica-based inorganic pore former” indicates the value of (D₍ₐ₎90−D₍ₐ₎10)/D₍ₐ₎50) of the silica-based inorganic pore former.

TABLE 1

| | Blending ratio (parts by mass) of cordierite forming raw material | | | | | | | | Blending ratio | | | Blending ratio of | | |
|---|---|---|---|---|---|---|---|---|---|---|---|---|---|---|
| | | | | | | Silica-based | | | (parts by mass) | | | other raw materials | | |
| | | | | | Aluminum | inorganic | | | of organic | | | (parts by mass) | | |
| | Talc | | Kaolin | Alumina | hydrixide | pore former | | | pore former | | | Binder | Surfactant | Water |
| Particle size | 20 | 30 | 5 | 6 | 3 | 25 | 26 | 35 | 30 | 40 | 300 | — | — | — |
| D50 (μm) | | | | | | | | | | | | | | |
| Example 1 | 40 | — | 10 | 25 | 5 | — | — | 20 | 5 | — | — | 6 | 1 | 85 |
| Example 2 | 40 | — | 10 | 25 | 5 | — | — | 20 | 5 | — | — | 6 | 1 | 85 |
| Example 3 | — | 40 | 10 | 25 | 5 | — | — | 20 | 5 | — | — | 6 | 1 | 85 |
| Example 4 | 40 | — | — | 30 | 5 | — | — | 25 | 5 | — | — | 6 | 1 | 85 |
| Example 5 | 40 | — | — | 30 | 5 | — | — | 25 | 4 | — | — | 6 | 1 | 75 |
| Comparative | 40 | — | 10 | 25 | 5 | 20 | — | — | — | 8 | — | 6 | 1 | 60 |
| Example 1 | | | | | | | | | | | | | | |
| Comparative | — | 40 | 10 | 25 | 5 | 20 | — | — | 4 | — | — | 6 | 1 | 80 |
| Example 2 | | | | | | | | | | | | | | |
| Comparative | 40 | — | 10 | 25 | 5 | 20 | — | — | 4 | — | — | 6 | 1 | 80 |
| Example 3 | | | | | | | | | | | | | | |
| Comparative | 40 | — | 10 | 25 | 5 | 20 | — | — | 4 | — | — | 6 | 1 | 85 |
| Example 4 | | | | | | | | | | | | | | |
| Comparative | 40 | — | 10 | 25 | 5 | 20 | — | — | — | — | 4 | 6 | 1 | 80 |
| Example 5 | | | | | | | | | | | | | | |
| Comparative | — | 40 | 10 | 25 | 5 | 15 | 5 | — | — | 8 | — | 6 | 1 | 60 |
| Example 6 | | | | | | | | | | | | | | |

TABLE 2

| | | | Pore Property | | | | Value of | |
|---|---|---|---|---|---|---|---|---|
| | Structure | | | Average | Half- | Open porosity | Expression (1) | |
| | Partition wall | Cell | | Pore | value | (%) of | of the silica- | Pressure |
| | Thickness | density | Porosity | Diameter | width of | partition wall | based inorganic | loss |
| | (μm) | (cells/cm²) | (%) | (μm) | first peak | surface | pore former ^{(*1)} | Evaluation |
| Example 1 | 254 | 46.5 | 66.3 | 22.6 | 0.182 | 34.4 | 1.21 | Good |
| Example 2 | 254 | 46.5 | 66.1 | 23.5 | 0.161 | 35.1 | 1.21 | Excellent |
| Example 3 | 254 | 46.5 | 64.3 | 24.6 | 0.194 | 35.5 | 1.21 | Good |
| Example 4 | 254 | 46.5 | 66.4 | 26.4 | 0.194 | 35.9 | 1.21 | Good |
| Example 5 | 254 | 46.5 | 62.6 | 23.7 | 0.161 | 35.1 | 1.21 | Excellent |
| Comparative | 254 | 46.5 | 61.8 | 19.1 | 0.250 | 28.9 | 1.81 | Base |
| Example 1 | | | | | | | | |
| Comparative | 254 | 46.5 | 63.8 | 23.6 | 0.227 | 29.5 | 1.81 | Available |
| Example 2 | | | | | | | | |
| Comparative | 254 | 46.5 | 65.3 | 20.0 | 0.243 | 28.5 | 1.81 | Available |
| Example 3 | | | | | | | | |
| Comparative | 254 | 46.5 | 65.3 | 21.2 | 0.209 | 29.0 | 1.81 | Available |
| Example 4 | | | | | | | | |
| Comparative | 254 | 46.5 | 65.6 | 24.8 | 0.242 | 30.2 | 1.81 | Available |
| Example 5 | | | | | | | | |
| Comparative | 254 | 46.5 | 60.9 | 24.6 | 0.235 | 30.2 | 1.81 | Available |
| Example 6 | | | | | | | | |

^{(*1)} Value of Expression (1) indicates “(D₍ₐ₎90 − D₍ₐ₎10)/D₍ₐ₎50”.

Next, the obtained kneaded material was molded using a continuous extrusion molding machine to produce a honeycomb formed body. Next, plugging portions were formed on the obtained honeycomb formed body. First, a mask was applied to the first end face of the honeycomb formed body so as to close the open ends of the remaining cells other than the predetermined cells. Next, the masked end portion (the end portion on the first end face side) was immersed in a slurry plugging material to fill the open ends of the predetermined cells, which were not masked, with the plugging material. Thereafter, a mask was applied to the second end face of the honeycomb formed body so as to close the open ends of the predetermined cells, and the open ends of the remaining cells other than the predetermined cells were filled with the plugging material in the same manner as described above.

Next, the honeycomb formed body with the plugging portions formed therein was fired such that the maximum temperature was 1420° C., thereby manufacturing the honeycomb filter of Example 1.

The honeycomb filter of Example 1 had an end face diameter of 132 mm and a length of 102 mm in the extending direction of the cells. The cell shape in the section orthogonal to the extending direction of the cells was quadrangular. Partition wall thickness of the honeycomb filter was 254 μm and the cell densities were 46.5 cells/cm². Table 2 shows partition wall thicknesses (μun) and cell densities (cells/cm²) of the honeycomb filter.

On the honeycomb filter of Example 1, the porosity and the average pore diameter of the partition wall were measured. Table 2 shows the result. The porosity and the average pore diameter were measured using Autopore IV (trade name) manufactured by Micromeritics. A part of the partition wall was cut out from the honeycomb filter to obtain a test piece, and the porosity was measured using the obtained test piece. The test piece was a rectangular parallelepiped having a length, a width, and a height of approximately 10 mm, approximately 10 mm, and approximately 20 mm, respectively. The sampling location of the test piece was set in the vicinity of the center of the honeycomb structure body in the axial direction. In determining the porosity and the average pore diameter, the true density of cordierite was taken as 2.52 g/cm³.

In addition, the cumulative pore volume of partition wall of the honeycomb filter of Example 1 was measured, and based on the measured result, a pore diameter distribution in which the horizontal axis represents log pore diameter (μm) and the vertical axis represents log differential pore volume (cm³/g) was created. Then, in the created pore diameter distribution, the half-value widths of the first peaks that included the maximum values of the log differential pore volumes were determined. Table 2 shows the result.

For the honeycomb filter of Example 1, the open porosity (%) of partition wall surface of pores which exist at a surface of the partition wall 1 and which have equivalent circle diameters exceeding 1.5 μm was measured. The measurement method is as described below. First, a sample for measurement was cut out from the honeycomb structure body such that the surface of the partition wall of the honeycomb structure body of the honeycomb filter of Example 1 could be observed. Then, the surface of the partition wall of the sample for measurement was photographed by a laser microscope. As the laser microscope, a shape analysis laser microscope of “VK X250/260 (trade name)” manufactured by KEYENCE Corporation was used. In the photographing of the surface of the partition wall, the magnification was set to 480 times, and arbitrary places of 10 fields of view were photographed. The captured image was processed to calculate the open porosity (%) of partition wall surface. In the image processing, an area was selected so as not to include a partition wall portion other than the surface of the partition wall, and the inclination of the surface of the partition wall was corrected to horizontal. Thereafter, the upper limit of the height recognized as pore was changed to −3.0 μm from the reference surface, and the open porosity (%) of the surface of the photographed image was calculated by the image processing software under the condition that pore having a circle equivalent diameter of 1.5 μm or less was ignored. The value of the open porosity (%) of partition wall surface was the average of the measured results of 10 fields of view. As the image processing software, “VK-X (trade name)” included with the shape analysis laser microscope of “VK X250/260 (trade name)” manufactured by KEYENCE Corporation was used. The measured results are shown in the column “Open porosity (%) of partition wall surface” in Table 2.

The honeycomb filter of Example 1 was evaluated for pressure loss in the following manner. Table 2 shows the result.

(Pressure Loss Evaluation)

Exhaust gas discharged from 1.2 L direct injection type gasoline engine was introduced at a flow rate of 600 m³/h at 700° C., and the pressures on the inflow end face side and the outflow end face side of the honeycomb filter were measured. Then, the pressure loss (kPa) of each of the honeycomb filters was determined by calculating the pressure difference between the inflow end face side and the outflow end face side. Then, when the value of pressure loss of the honeycomb filter of Comparative Example 1 was 100%, the values (%) of pressure loss were calculated for the respective honeycomb filter of Examples and Comparative Examples. The value (%) of pressure loss calculated in this manner was defined as the “pressure loss ratio (%)” in the pressure loss evaluation. In the pressure loss evaluation, the respective honeycomb filter of Examples and Comparative Examples were evaluated based on the evaluation criteria described below.

Evaluation “Excellent”: If the value of the pressure loss ratio (%) is 90% or less, then the evaluation is determined as “Excellent”.

Evaluation “Good”: If the value of the pressure loss ratio (%) is greater than 90% and 95% or less, then the evaluation is determined as “Good”.

Evaluation “Acceptable”: If the value of the pressure loss ratio (%) is greater than 95% and 100% or less, then the evaluation is determined as “Acceptable”.

Evaluation “Fail”: If the value of the pressure loss ratio (%) exceeds 100%, then the evaluation is determined as “Fail”.

### Examples 2 to 5

In Examples 2 to 5, the blending ratio (parts by mass) of each raw material used for the cordierite forming raw material was changed as shown in Table 1. In addition, the blending ratios (parts by mass) of the organic pore former and other raw materials were also changed as shown in Table 1. Except that these raw materials were used to prepare the kneaded material, the honeycomb filters were manufactured by the same method as that of Example 1.

### Comparative Examples 1 to 6

In Comparative Examples 1 to 6, the blending ratio (parts by mass) of each raw material used for the cordierite forming raw material was changed as shown in Table 1. In addition, the blending ratios (parts by mass) of the organic pore former and other raw materials were also changed as shown in Table 1. Except that these raw materials were used to prepare the kneaded material, the honeycomb filters were manufactured by the same method as that of Example 1.

The honeycomb filters of Example 2 to 5 and Comparative Examples 1 to 6 were also evaluated for pressure loss in the same manner as in Example 1. Table 2 shows the result.

(Results)

In the honeycomb filters of Example 1 to 5, both the results of pressure loss evaluations were “Excellent” or “Good”, and the increase in pressure loss was suppressed very effectively. On the other hand, the honeycomb filters of Comparative Examples 1 to 6 were inferior to the honeycomb filters of Examples 1 to 5 in the results of pressure loss evaluation. In particular, for the honeycomb filters of Comparative Examples 1 to 6, the half-value width of the first peaks exceeds 0.20 and the open porosity of partition wall surface is less than 31%, as shown in Table 2, and it is inferred that these characteristics affect the results of pressure loss evaluations. For example, the honeycomb filter of Comparative Example 1 exhibited a higher porosity of the partition wall compared to the honeycomb filters of Examples 3 and 5, while the results of pressure loss evaluations were inferior to the honeycomb filters of Examples 3 and 5. In the honeycomb filter of Comparative Example 2, the average pore diameter of the partition wall showed values equivalent to those of the honeycomb filter of Example 1, however, the results of pressure loss evaluations were inferior to those of the honeycomb filter of Example 1.

### INDUSTRIAL APPLICABILITY

The honeycomb filter according to the present invention can be used as a trapping filter for removing particulates and the like contained in exhaust gas.

### DESCRIPTION OF REFERENCE NUMERALS

1: partition wall, 2: cell, 2a: inflow cell, 2b: outflow cell, 3: circumferential wall, 4: honeycomb structure body, 5: plugging portion, 11: first end face, 12: second end face, 100: honeycomb filter

What is claimed is:

1. A honeycomb filter comprising:
a pillar-shaped honeycomb structure body having a porous partition wall disposed to surround a plurality of cells which serve as fluid through channels extending from a first end face to a second end face; and
a plugging portion provided at an open end on the first end face side or the second end face side of each of the cells,
wherein the partition wall is composed of a material containing cordierite as a main component thereof,
a porosity of the partition wall is 60 to 70%,
an average pore diameter of the partition wall is 20 to 30 μm,
an open porosity of pores which exist at a surface of the partition wall and which have equivalent circle diameters exceeding 1.5 μm is 31% or more, and,
in a pore diameter distribution which indicates a cumulative pore volume of the partition wall, with a log pore diameter on a horizontal axis and a log differential pore volume (cm³/g) on a vertical axis, a half-value width of a first peak that includes a maximum value of the log differential pore volume is 0.20 or less.

2. The honeycomb filter according to claim 1, wherein an average equivalent circle diameter of the pores which exists at the surface of the partition wall and which have equivalent circle diameters exceeding 1.5 μm is 5.0 to 15.0 μm.

3. The honeycomb filter according to claim 1, wherein the half-value width of the first peak is less than 0.20.

4. The honeycomb filter according to claim 1, wherein the thickness of the partition wall is 152 to 305 μm.

5. A manufacturing method of a honeycomb filter according to claim 1 comprising:
a kneaded material preparation process for preparing a plastic kneaded material by adding an organic pore former and a dispersing medium to a cordierite forming raw material;
a forming process for forming the obtained kneaded material into a honeycomb shape to produce a honeycomb formed body; and
a firing process for firing the obtained honeycomb formed body to obtain a honeycomb filter,
wherein the cordierite forming raw material contains at least one of porous silica and fused silica as an inorganic pore former,
in a cumulative particle size distribution of the porous silica and the fused silica as the inorganic pore former based on volume by the laser diffraction/scattering type particle size distribution measurement method, a particle diameter (μm) of 10% by volume of a total volume from a small diameter side is denoted by D₍ₐ₎10, a particle diameter (μm) of 50% by volume of the total volume from the small diameter side is denoted by D₍ₐ₎50, a particle diameter (μm) of 90% by volume of the total volume from the small diameter side is denoted by D₍ₐ₎90, and the inorganic pore former that satisfy a relationship of following expression (1) is used.
1.00<(D₍ₐ₎90−D₍ₐ₎10)/D₍ₐ₎50<1.50 Expression (1):
